(19) United States
(12) Patent Application Publication
(10) Pub. No.: US 2026/0078805 A1
(43) Pub. Date: Mar. 19, 2026

(54) BEARING SYSTEM WITH INTEGRATED ELECTRICAL INSULATION, IN PARTICULAR FOR AN ELECTRIC MOTOR OR MACHINE

(71) Applicant: AKTIEBOLAGET SKF, GOTEBORG (SE)

(72) Inventor: Benoit ARNAULT, Saint-Cyr-sur-Loire (FR)

(21) Appl. No.: 19/323,034

(22) Filed: Sep. 9, 2025

(30) Foreign Application Priority Data
Sep. 16, 2024 (FR) 2409813

(51) Int. Cl. F16C 41/00; F16C 19/06

(52) U.S. Cl. CPC F16C 41/002; F16C 19/06; F16C 2380/26

(57) ABSTRACT

A bearing device includes a bearing having a first ring and a second ring configured to rotate relative to each other about a central axis, a bushing, an electrically insulating insert overmolded between and connecting the bushing and the second ring, and a sealing device mounted on the electrically insulating insert and forming a first dynamic annular seal with the first ring. The electrically insulating insert includes a plurality of circumferentially spaced radially extending retaining hooks that hold the sealing device against a portion of the electrically insulating insert.

### CROSS-REFERENCE

This application claims priority to French patent application no. 2409813 filed on September 16, 2024, the contents of which are fully incorporated herein by reference.

### TECHNOLOGICAL FIELD

The present disclosure relates to the field of electrically insulated bearings used, in particular, in electric motors, electric machines and associated equipment.

### BACKGROUND

In an electric motor or an electric machine, at least one rolling bearing is mounted between the housing of the electric motor or the electric machine and the rotating shaft in order to support this shaft. During operation when the shaft is in rotation, a difference in electrical potential can occur between the shaft and the housing of the electric motor or the electric machine, and this can generate an electric current between the inner ring of the rolling bearing which is fixed to the shaft and the outer ring which is fixed to the housing.

The electric current passing through the components of the rolling bearing can damage these components, in particular the rolling elements and the raceways formed on the internal and outer rings. The electrical discharges can also generate vibrations. In order to remedy these drawbacks, it is known to replace the rolling elements of the bearing, which are formed from the same steel as that of the internal and outer rings, with rolling elements which are manufactured from ceramic. Generally this is referred to as a hybrid rolling bearing. However, such a hybrid rolling bearing is relatively costly.

In order to remedy the aforementioned drawbacks, it is also known to provide the outer ring of the rolling bearing with an insulating sleeve which is provided with a bushing and an insulating insert which is formed from electrically insulating material and which is radially interposed between the outer ring and the bushing.

In some applications, environmental pollution can reduce the service life of the bearing.

### SUMMARY

The disclosure relates to a bearing device comprising a bearing which has a first ring and a second ring which are configured to rotate relative to one another. The system also comprises at least one insulating sleeve which is mounted on the second ring of the bearing. The insulating sleeve comprises a bushing and an insulating insert which is interposed radially between the second ring of the bearing and the bushing. The insulating insert is formed from electrically insulating material.

The bushing has an external surface and an internal surface opposing the external surface which surfaces delimit the radial thickness of the bushing. The insulating insert is fixed to the second ring of the bearing and at least to one of the external and internal surfaces of the bushing.

According to a general feature, the system also comprises at least one first sealing device mounted on the insulating insert and forming a first dynamic annular seal with the first ring. According to a further general feature, the insulating insert comprises at least first axial retaining hooks of the first sealing device which are spaced apart relative to one another in the circumferential direction.

A "dynamic seal" is understood to mean a seal between two parts which are able to have relative movement. In contrast to a dynamic seal, a "static seal" is understood to mean the seal produced between two parts which are not able to have relative movement.

The first dynamic annular seal formed jointly by the first sealing device and by the first ring can be obtained by a narrow passage or narrow passages and/or by friction. The first sealing device forms a barrier stopping polluting particles which can move toward the inside of the bearing.

Preferably, the insulating insert comprises at least one first axial projection extending axially toward the outside and supporting the first axial retaining hooks.

The second ring can comprise an external surface and an internal surface opposing the external surface which surfaces delimit the radial thickness of the second ring, and first and second front faces delimiting the axial length of the second ring, the insulating insert being fixed to at least one of the external and internal surfaces of the second ring.

According to an advantageous design, the insulating insert comprises at least one first radial projection extending radially and at least partially covering the first front face of the second ring, the first sealing device being held axially bearing thereagainst by the first axial retaining hooks. Alternatively, it is possible for the first axial retaining hooks to hold the first sealing device axially against the second ring. Preferably, the first axial retaining hooks are formed in one piece with the insulating insert. Alternatively, the first axial retaining hooks could be attached to the insulating insert.

Advantageously, the insulating insert is overmolded on the second ring of the bearing and at least on the surface of the bushing. Alternatively, the insulating insert can be fixed by any other appropriate means, for example by adhesive bonding. Preferably, the first axial retaining hooks of the insulating insert extend radially on the side of the first ring.

According to one particular design, the first sealing device comprises a fixing part fixed in the first annular mounting groove of the insulating insert and formed from rigid material, the insulating insert being formed from flexible electrically insulating material. The first sealing device can comprise a sealing flange. Alternatively, the first sealing device can comprise a sealing gasket. Advantageously, the system can also comprise at least one second sealing device mounted on the insulating insert and forming with the first ring a second dynamic annular seal. The second dynamic annular seal formed jointly by the second sealing device and by the first ring can be obtained by a narrow passage or narrow passages and/or by friction.

The insulating insert comprises at least second axial retaining hooks of the second sealing device which are spaced apart relative to one another in the circumferential direction. The first and second sealing devices are arranged axially on either side of the second ring.

The first ring can comprise first and second front faces delimiting the axial length of the second ring. The first front face of the second ring and the first front face of the first ring are located axially on a first side relative to a radial median plane of the system. The second front face of the second ring and the second front face of the first ring are located axially on a second side relative to the radial median plane.

Advantageously, the first front face of the second ring is offset axially toward the inside relative to the first front face of the first ring and the first sealing device is located axially between the first front faces. Thus the overall axial bulk of the system is not increased, given the presence of the first sealing device. Moreover, the overall weight of the system is reduced, given the reduced axial length of the second ring relative to that of the first ring.

Advantageously, the second front face of the second ring is offset axially toward the inside relative to the second front face of the first ring. When the system is provided with a second sealing device, this can advantageously be located axially between the second front faces.

If the insulating insert is formed from synthetic material or from elastomeric material, it enables the system to be made insensitive to temperature variations. In one particular embodiment, the bushing is formed from metallic material. The bushing can thus be easily machined to a predetermined radial tolerance. Advantageously, the bushing is obtained from a sheet metal blank by cutting, stamping and rolling.

In one embodiment, the insulating insert covers the entire surface of the bushing. In this case, the insulating insert covers the surface of the bushing entirely in the axial direction and in the circumferential direction.

According to a first design, the bushing delimits the external surface of the system. In this case, the second ring is the outer ring of the bearing. According to a second alternative design, the bushing delimits the internal surface of the system. In this case, the second ring is the inner ring of the bearing.

In one particular embodiment, the bearing comprises at least one row of rolling elements which are arranged between the raceways of the first and second rings. The rolling elements can be formed from metallic material.

The disclosure further relates to an electric motor comprising a housing, a shaft and at least one bearing device as defined above and mounted radially between the housing and the shaft.

### BRIEF DESCRIPTION OF THE DRAWINGS

The present disclosure will be understood more clearly by studying the detailed description of embodiments provided by way of non-limiting examples illustrated by the accompanying drawings, in which:

FIG. 1 is a perspective view of a bearing device according to a first exemplary embodiment of the present disclosure which includes two sealing flanges.

FIG. 2 is a perspective view of the bearing device of FIG. 1 in which one of the sealing flanges has been removed for illustration purposes.

FIG. 3 is a perspective view of one of the sealing flanges of the bearing device of FIG. 1.

FIG. 4 is an axial sectional view of a portion of the bearing device of FIG. 1.

FIG. 5 is an axial sectional view of a portion of the bearing device of FIG. 1 in which the sealing flanges are not shown.

FIG. 6 is an axial section of a portion of a bearing device according to a second exemplary embodiment of the disclosure.

FIG. 7 is an axial sectional view of a portion of a bearing device according to a third exemplary embodiment of the disclosure.

FIG. 8 is an axial sectional view of a portion of a bearing device according to a fourth exemplary embodiment of the disclosure.

FIG. 9 is a perspective view of the bearing device of FIG. 8.

FIG. 10 is a perspective view of the bearing device of FIGS. 8 and 9 in which an inner ring, rolling elements and a cage are omitted for illustration purposes.

### DETAILED DESCRIPTION

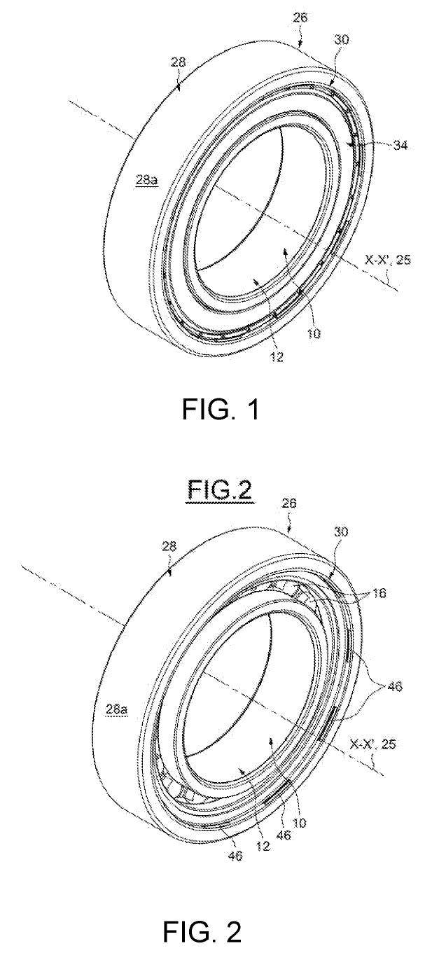

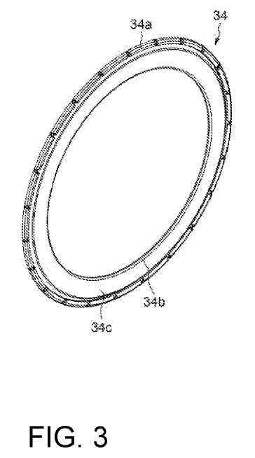

The bearing device illustrated in FIGS. 1 to 5 comprises a bearing 10 which includes a first ring 12 and a second ring 14 that are configured to rotate relative to one another around the axis X – X' of the bearing. In the illustrated exemplary embodiment, the first ring 12 is the inner ring of the bearing and the second ring 14 is the outer ring. The bearing device is designed so as not to conduct electric currents. The bearing device has integrated electrical insulation.

The inner ring 12 and the outer ring 14 of the bearing are concentric and extend axially along the axis X – X' of the bearing. The inner ring 12 and the outer ring 14 are formed from steel. The rings are of the solid type.

In the illustrated exemplary embodiment, the bearing 10 also comprises a row of rolling elements 16, in this case balls, interposed radially between the inner ring 12 and the outer ring 14. The rolling elements 16 are formed from steel. The bearing 10 also comprises a cage 17 for maintaining a uniform circumferential spacing of the rolling elements 16.

The inner ring 12 comprises a cylindrical bore 12a, a cylindrical axially extending external surface 12b and first and second radial front faces 12c, 12d axially delimiting the bore and the axially extending external surface. The bore 12a and the external surface 12b delimit the radial thickness of the inner ring 12. The bore 12a forms the internal surface of the inner ring. The first and second front faces 12c, 12d delimit the axial length of the inner ring 12. The inner ring 12 also has an internal raceway 18 for the rolling elements 16 which is formed on the external surface 12b. The raceway 18 faces radially outward.

The outer ring 14 has a cylindrical axially extending external surface 14a, a cylindrical bore 14b radially opposite the external surface 14a and first and second radial front faces 14c, 14d axially delimiting the bore 14b and the axially extending external surface 14a. The external surface 14a and the bore 14b delimit the radial thickness of the outer ring 14. The first and second faces 14c, 14d delimit the axial length of the outer ring 14. The outer ring 14 also has an external raceway 20 for the rolling elements 16, which is formed on the bore 14b. The raceway 20 faces radially inward.

The bearing device also comprises an electrical insulating sleeve 26 which is mounted on the external surface 14a of the outer ring 14. The insulating sleeve 26 is fixed to the outer ring 14. The insulating sleeve 26 comprises a bushing 28 and an insulating insert 30 interposed radially between the outer ring 14 and the bushing 28. In this case, the insulating insert 30 is overmolded on the outer ring 14 and on the bushing 28.

As will be described in more detail hereinafter, the bearing device further comprises first and second sealing flanges 32, 34 fixed to the insulating insert 30.

The bushing 28 is of annular shape. The bushing 28 is produced in one piece. The bushing 28 is produced in this case as a single component. Preferably, the bushing 28 is formed from steel. The bushing 28 can advantageously be obtained from a tube or from forged and/or rolled blanks, or even from stamping.

The bushing 28 comprises a cylindrical axially extending external surface 28a and a cylindrical axially extending internal surface 28b. The axially extending inner surface 28b forms the internal surface of the bushing 28. The axially extending inner surface 28b faces the outer ring 14 and the insulating insert 30. The axis 25 of the axially extending inner surface 28b is coaxial with the axis X - X'. The axially extending inner surface 28b is radially spaced from the external surface 14a of the outer ring.

The external surface 28a and the axially extending inner surface 28b delimit the radial thickness of the bushing 28. The external surface 28a of the bushing forms the external surface of the bearing device 10. In other words, the external surface 28a defines the external diameter of the bearing device 10.

The bushing 28 also comprises opposing first and second radially extending front faces 28c, 28d axially delimiting the bore and the external surface. The front faces 28c, 28d delimit the axial length of the bushing.

The front faces 14c, 28c of the outer ring and the bushing are located axially on a first side relative to a radial median plane P of the system, and the front faces 14d, 28d of the outer ring and the bushing are located axially on a second side, relative to the radial median plane P, which opposes the first side. The radial median plane P passes in this case through the center of the rolling elements 16.

The front face 14c of the outer ring is offset axially toward the inside relative to the front face 28c of the bushing. The front face 14d of the outer ring is offset axially toward the inside relative to the front face 28d of the bushing. In other words, the front faces 14c, 14d of the outer ring are axially inset relative to the front faces 28c, 28d of the bushing. The axial dimension of the outer ring 14 is less than the axial dimension of the bushing 28.

The front face 14c of the outer ring is offset axially inward relative to the front face 12c of the inner ring. The front face 14d of the outer ring is offset axially inward relative to the front face 12d of the inner ring.

The insulating insert 30 is formed from electrically insulating material. The insulating insert 30 can be produced, for example, from synthetic material, such as a PEEK or a PA46, or even formed from elastomeric material, for example from rubber. Advantageously, the insulating insert 30 is formed from flexible electrically insulating material. The insulating insert 30 is radially interposed between the external surface 14a of the outer ring and the axially extending inner surface 28b of the bushing. The insulating insert 30 covers the external surface 14a of the outer ring. In this case, the insulating insert 30 entirely covers the external surface 14a of the outer ring, when considering the axial and circumferential directions. The insulating insert 30 also covers the front faces 14c, 14d of the outer ring.

The insulating insert 30 also covers the axially extending inner surface 28b of the bushing. In this case, the insulating insert 30 also entirely covers the axially extending inner surface 28b, when considering the axial and circumferential directions.

The insulating insert 30 is annular. The insulating insert 30 extends axially. The insulating insert 30 comprises a cylindrical axial external surface 30a, a cylindrical inner surface 30b radially opposing the external surface 30a and opposing first and second radial front faces 30c, 30d axially delimiting the bore and the external surface. The radial front faces 30c, 30d axially delimit the insulating insert 30. The external surface 30a and the cylindrical inner surface 30b delimit the radial thickness of the insulating insert 30. The external surface 30a is in radial contact with the axially extending inner surface 28b of the bushing. The cylindrical inner surface 30b is in radial contact with the external surface 14a and with the front faces 14c, 14d of the outer ring. The cylindrical inner surface 30b has a stepped shape.

The front face 14c of the outer ring is offset axially inward relative to the front face 30c of the insulating insert. The front face 14d of the outer ring is offset axially inward relative to the front face 30d of the insulating insert.

In the illustrated exemplary embodiment, the faces 30c, 28c and 30d, 28d of the insulating insert and of the bushing are respectively substantially coplanar. Alternatively, it is possible to provide different arrangements. For example, the bushing 28 could extend so as to protrude axially from the insulating insert 30 relative to the faces 30c and 30d or remain axially retracted from these faces. In the illustrated exemplary embodiment, the faces 12c, 28c and 12d, 28d of the inner ring and the bushing are respectively coplanar. Alternatively, it is possible to provide different arrangements. For example, the bushing 28 could extend so as to protrude axially relative to the faces 12c and 12d of the inner ring or remain axially retracted from these faces.

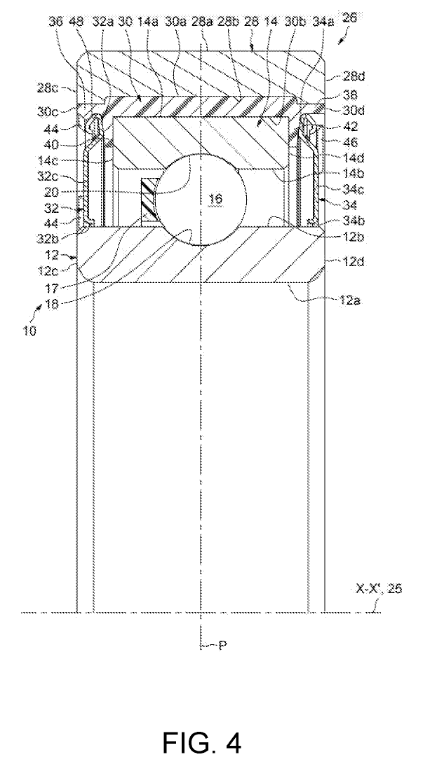

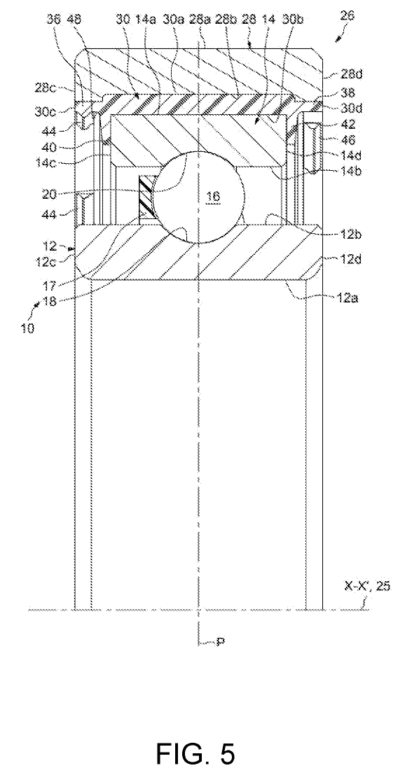

As illustrated more clearly in FIGS. 4 and 5, the insulating insert 30 comprises first and second annular axial projections 36, 38 extending axially toward the outside.

The projections 36, 38 are located on either axial side of the insulating insert 30. The projection 36 extends so as to protrude axially outward on one side of the insulating insert, and the projection 38 extends so as to protrude axially outward on the other side of the insulating insert. The free end of the projection 36 delimits the front face 30c of the insulating insert, and the free end of the projection 38 delimits the front face 30d of the insulating insert. The projections 36, 38 are symmetrical to one another relative to the radial median plane P of the system.

As indicated above, the insulating insert 30 covers the front faces 14c, 14d of the outer ring. The insulating insert 30 comprises first and second radially inwardly extending annular projections 40, 42 that cover, respectively, the front faces 14c, 14d. The projections 40, 42 are symmetrical to one another relative to the radial median plane P of the system. The projection 36 extends so as to protrude axially outward relative to the projection 40. The projection 38 extends so as to protrude axially outward relative to the projection 42.

The insulating insert 30 comprises first hooks 44 and second hooks 46 to ensure the axial retention of the sealing flanges 32, 34, respectively, on the lining. The hooks 44, 46 are produced in one piece, i.e. in the same material, with the insulating insert 30.

The hooks 44 are supported by the projection 36 of the insulating insert. The hooks 44 extend radially inwardly, i.e. in the direction of the inner ring 12. The hooks 44 are formed on the bore of the projection 36. The hooks 44 are spaced apart relative to one another in the circumferential direction, i.e. in this case in a uniform manner. Alternatively, the circumferential spacing of the hooks 44 could be non-uniform. The hooks 44 in this case are axially inset relative to the front face 30c of the insulating insert. The hooks 44 are identical to one another in this case. Alternatively, the shape and/or circumferential dimension of the hooks may not be identical. The hooks 44 in this case are ten in number. Alternatively, it is possible to provide a different number of hooks.

The hooks 44 ensure the axial retention of the sealing flange 32 on the insulating insert 30 by diametral interference. The hooks 44 have an internal diameter which is less than the external diameter of the sealing flange 32. The hooks 44 cooperate with the sealing flange 32 by being clipped in. Each hook 44 comprises a bearing surface (not referenced) which is oriented inward and brought to bear axially against the sealing flange 32. The sealing flange 32 is fixed to the insulating insert by bearing axially on one side against the hooks 44 and on the other side against the projection 40. The hooks 44 hold the sealing flange 32 axially bearing against the projection 40. The sealing flange 32 bears axially against the projection 40 axially on the side opposing the outer ring 14. The sealing flange 32 bears radially against the bore of the projection 36.

A recess 48 is locally formed axially between each hook 44 and the projection 40, the sealing flange 32 being fixed therein. A plurality of recesses 48 is thus formed on the bore of the projection 36. The recesses 48 are spaced apart relative to one another in the circumferential direction. The sealing flange 32 is fixed in the bore of the projection 36.

In a similar manner, the hooks 46 are supported by the projection 38 of the insulating insert. The hooks 46 extend radially toward the inside, i.e. in the direction of the inner ring 12. The hooks 46 are formed on the bore of the projection 38. The hooks 46 are spaced apart relative to one another in the circumferential direction, i.e. in a uniform manner in this case. Alternatively, the circumferential spacing of the hooks 46 could be non-uniform. The hooks 46 in this case are axially inset relative to the front face 30d of the insulating insert. The hooks 46 are identical to one another in this case. Alternatively, the shape and/or circumferential dimension of the hooks may not be identical.

The hooks 46 ensure the axial retention of the sealing flange 34 on the insulating insert 30 by diametral interference. The hooks 46 have an internal diameter which is less than the external diameter of the sealing flange 34. The hooks 46 cooperate with the sealing flange 34 by being clipped in. Each hook 46 comprises a bearing surface (not referenced) which is oriented inwardly and brought to bear axially against the sealing flange 34. The sealing flange 34 is fixed to the insulating insert by bearing axially on one side against the hooks 46 and on the other side against the projection 42. The hooks 46 hold the sealing flange 34 axially bearing against the projection 42. The sealing flange 34 bears axially against the projection 42 axially on the side opposing the outer ring 14. The sealing flange 34 bears radially against the bore of the projection 38.

A recess (not referenced) is locally formed axially between each hook 46 and the projection 42, the sealing flange 34 being fixed therein. A plurality of recesses is thus formed on the bore of the projection 38. The recesses are spaced apart relative to one another in the circumferential direction. The sealing flange 34 is fixed in the bore of the projection 38.

The sealing flanges 32, 34 are located axially on each side of the insulating insert 30 to close the radial space present between this insulating insert and the inner ring 12, the outer ring 14, the rolling elements 16 and the cage 17 being housed therein. The sealing flanges 32, 34 are located axially on either side of the outer ring 14. In this exemplary embodiment, the sealing flanges 32, 34 are identical to one another and symmetrical relative to the median plane P of the system.

Each sealing flange 32, 34 is arranged radially between the insulating insert 30 and the inner ring 12 and fixed to the insulating insert by being arranged laterally to the outer ring 14.

Each sealing flange 32, 34 is entirely housed inside the radial space delimited by the insulating insert 30 and the inner ring 12. The sealing flange 32, 34 is located axially between the front face 14, 14d of the outer ring and the front face 28, 28d of the bushing. The sealing flange 32, respectively 34, is offset axially on the internal side of the system relative to the front faces 12c, 28c and 30c, respectively 12d, 28d and 30d, of the inner ring 12 of the bushing 28 and of the insulating insert 30.

Each sealing flange 32, 34 is formed from a rigid material, for example metallic material or thermoplastic material, in particular polyamide. Each sealing flange 32, 34 comprises a fixing portion 32a, 34a, which bears axially on one side against the hooks 44, 46 and on the other side against the projection 40, 42 of the insulating insert, a sealing portion 32b, 34b which cooperates with the inner ring 12 and a connecting portion 32c, 34c which connects the fixing and sealing portions.

The fixing portion 32a, 34a of the sealing flange cooperates with the hooks 44, 46 to fix the sealing flange 32, 34 to the insulating insert 30. In the illustrated exemplary embodiment, the fixing portion 32a, 34a of the sealing flange 32, 34 is produced in the form of regions which are folded back onto themselves. The regions are spaced apart relative to one another in the circumferential direction. In the illustrated exemplary embodiment, the circumferential dimension of each hook 44, 46 is such that it cooperates with two successive regions of the fixing portion 32a, 34a of the associated sealing flange. Alternatively, each hook 44, 46 could cooperate with a different number of regions. In a further variant, the fixing portion 32a, 34a of the sealing flange 32, 34 could be annular.

The sealing portion 32b, 34b of each sealing flange is in the form of an annular axial portion which radially surrounds the external surface 12b of the inner ring to form a labyrinth-type narrow passage with the external surface. The sealing portion 32b, 34b of each sealing flange forms a dynamic annular seal with the external surface 12b of the inner ring 12. Alternatively, the sealing portion 32b, 34b of each sealing flange, or one of the two sealing flanges, could form a dynamic seal with another part of the inner ring 12, for example the front face 12c, 12d.

To manufacture the bearing device, the disclosure proceeds in the following manner. In a first step, the bushing 28 and the outer ring 14 of the bearing are mounted inside a mold which is provided for overmolding the insulating insert 30. Then in a second step, the insulating insert 30 is overmolded both on the outer ring 14 and on the bushing 28. The hooks 44, 46 are formed during this step. Then in a third successive step, the unitary assembly formed by the outer ring 14, by the bushing 28 and by the insulating insert 30 is removed from the mold. Then in a fourth step, the front faces 28c, 28d of the bushing are ground. During this step, the external surface 28a of the bushing and the bearing race 20 of the outer ring can also be ground. Finally in a fifth step, the unitary assembly formed by the outer ring 14, the bushing 28 and the insulating insert 30 is assembled with the row of rolling elements 16, the cage 17, the inner ring 12 and the sealing flanges 32, 34.

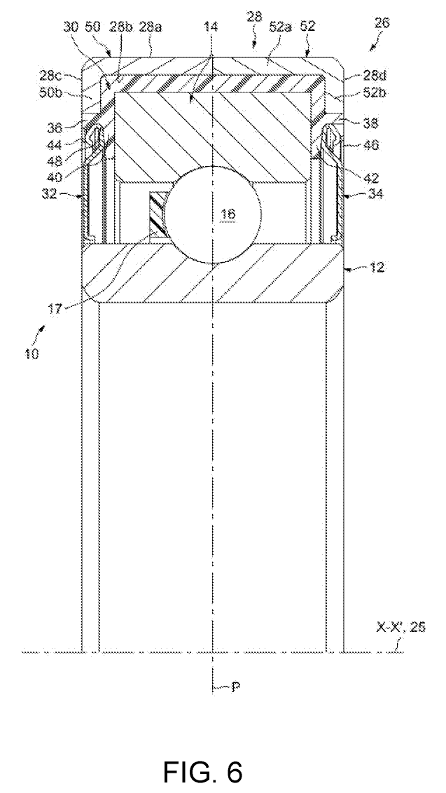

The exemplary embodiment illustrated in FIG. 6, in which identical elements bear the same reference signs, differs from the first example in that the bushing 28 comprise two separate parts 50, 52. These two separate parts 50, 52 form half-flanges which axially bear against one another. In the illustrated exemplary embodiment, the parts 50, 52 of the bushing are identical and symmetrical relative to the radial median plane P of the system in order to reduce manufacturing costs. Alternatively, it is naturally possible to provide non-symmetrical parts 50, 52. In a further variant, it could be possible for the bushing 28 to comprise more than two parts. In a further variant, the bushing 28 could be produced in one piece. Preferably, the parts 50, 52 of the bushing 28 are formed from steel. The parts 50, 52 can advantageously be obtained from a sheet metal blank by cutting, stamping and rolling.

Each part 50, 52 of the bushing comprises an annular axial portion 50a, 52a and an annular radial collar 50b, 52b extending the axial portion radially toward the inside. The axial portions 50a, 52a bear axially against one another. The radial collar 50b, 52b extends the end of the axial portion 50a, 52a located axially on the external side of the system. In the illustrated exemplary embodiment, the radial collars 50b, 52b are annular. Alternatively, at least one of the radial collars 50b, 52b could be in the form of regions which are spaced apart relative to one another in the circumferential direction. In the illustrated exemplary embodiment, the radial collars 50b, 52b of the bushing extend radially beyond the external surface 14a of the outer ring, i.e. radially protrude toward the inside relative to the external surface 14a.

The axial portions 50a, 52a of the parts of the bushing jointly delimit the external surface 28a of the bushing. In a similar manner, the axial portions 50a, 52a jointly delimit the axially extending inner surface 28b of the bushing. The front face 28c of the bushing is delimited by the radial collar 50b and the front face 28d is delimited by the radial collar 52b. More specifically, the front face 28c is delimited by the external face of the radial collar 50b and the front face 28d is delimited by the external face of the radial collar 52b.

The insulating insert 30 covers the internal face of each collar 50b, 52b of the bushing. The internal face and the external face axially opposing the internal face of each collar 50b, 52b delimit the axial thickness of the collar. For each collar 50b and 52b, the internal face is oriented axially toward the inside of the system and the external face is oriented axially toward the outside of the system. The insulating insert 30 also covers the free end of each collar 50b, 52b of the bushing. More specifically, the projection 44, 46 covers the free end of the collar 50b, 52b of the bushing. The sealing flange 32, 34 is located axially between the front face 14, 14d of the outer ring and the front face 28c, 28d of the bushing delimited by the external face of the radial collar 50b, 50c of the bushing. The radial collar 50b, 50c of the bushing radially surrounds the sealing flange 32, 34.

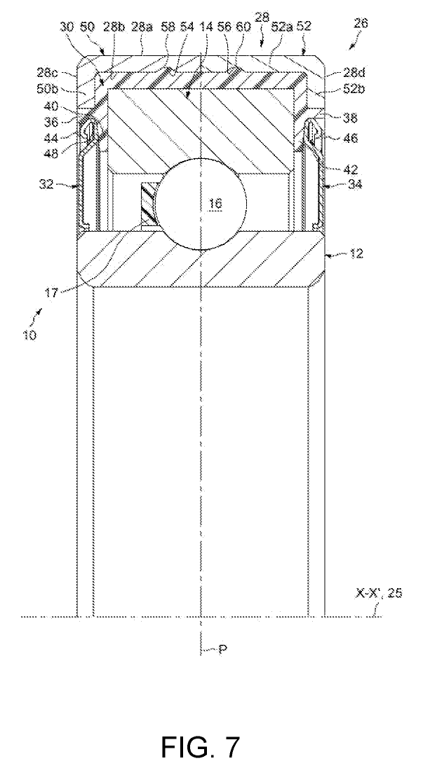

The exemplary embodiment illustrated in FIG. 7, in which identical elements bear the same reference signs, differs from the second example in that the bore of the axial portion 50a, 52a of each part 50, 52 of the bushing has a groove 54, 56 which extends circumferentially around the axis 25 of the bore of the bushing. Each groove 54, 56 is oriented radially on the side of the outer ring 14, i.e. radially toward the inside.

In the illustrated exemplary embodiment, each groove 54, 56 is annular. Alternatively, it could be possible that at least one of the two grooves 54, 56 does not extend over 360º or it could even be possible that it is formed by a succession of turns extending circumferentially and spaced apart relative to one another in the circumferential direction.

Each groove 54, 56 is delimited in the axial direction by two opposing lateral flanks which have a rectangular profile in axial section and which are connected together by an axial base. Alternatively, it is possible to provide other shapes, for example grooves, having in cross section a circular arc-shape oriented toward the inside.

The insulating insert 30 also comprises two ribs 58, 60 extending radially toward the outside from the external surface 30a and each housed inside one of the grooves 54, 56 of the bushing. The rib 58, 60 has a complementary shape to the associated groove 54, 56. Each rib 58, 60 extends so as to protrude relative to the external surface 30a of the insulating insert. Each rib 58, 60 is formed on the external surface 30a during the overmolding of the insulating insert 30.

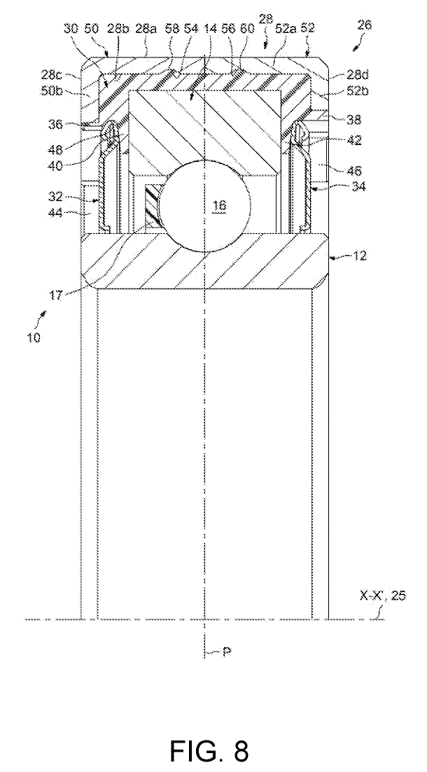

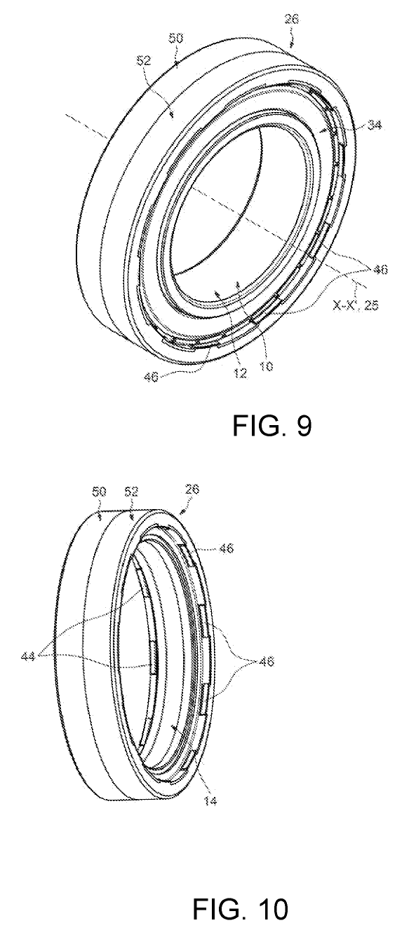

The exemplary embodiment illustrated in FIGS. 8 to 10, in which identical elements bear the same reference signs, differs from the above example, in particular by the axial arrangement of the sealing flanges 32, 34. The sealing flange 32, 34 is located in this case axially between the front face 14, 14d of the outer ring and the internal face of the radial collar 50b, 50c of the bushing. The sealing flange 32, 34 is offset axially toward the inside relative to the internal face of the radial collar 50b, 50c of the bushing. This makes it possible to increase locally the radial dimension of the radial collars 50b, 50c of the bushing which in this case each have a notched shape in the circumferential direction in the region of their free edge. With a greater local radial dimension of the radial collars 50b, 50c of the bushing, the bearing surface is increased between the system and the housing of the associated electric motor.

In the illustrated exemplary embodiments, the bearing device comprises sealing flanges. As a variant, the bearing device could comprise further sealing devices, replacing the sealing flanges by sealing gaskets, for example.

In the illustrated exemplary embodiments, the first ring 12 of the bearing is the inner ring and the second ring 14 on which the insulating insert 30 is overmolded is the outer ring. Alternatively, it is possible to provide a reverse arrangement in which the second ring 14, to which the insulating insert 30 is fixed, is the inner ring. In this case, the insulating sleeve is located in the bore 12a of the inner ring. The insulating insert is thus interposed radially between the bore 12a of the inner ring and the external surface of the bushing. The insulating insert is fixed at least to the internal surface of the inner ring and at least to the external surface of the bushing. The bore of the bushing delimits the bore of the bearing device. The sealing device or the sealing devices are fixed to the external surface of the insulating insert.

In the exemplary embodiments described, the bearing of the system is provided with a single row of rolling elements. In one variant, the bearing can be provided with a plurality of rows of rolling elements. Moreover, the rolling bearing can comprise different types of rolling elements from balls, for example rollers. In a further variant, the bearing can be a plain bearing without rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved electrically insulated bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other about a central axis, the second ring having a first axial end and a second axial end axially spaced from the first axial end and a first radial side extending from the first axial end to the second axial end and a second radial side extending from the first axial end to the second axial end, the second radial side being radially spaced from the first radial side,
a bushing,
an electrically insulating insert overmolded between and connecting the bushing and the second radial side of the second ring, and
a first sealing device mounted on the electrically insulating insert and forming a first dynamic annular seal with the first ring, the electrically insulating insert including a plurality of circumferentially spaced first radially extending retaining hooks holding the first sealing device against a first portion of the electrically insulating insert.

2. The bearing device according to claim 1,
wherein the electrically insulating insert comprises at least one first axial projection extending axially away from the second ring, and
wherein at least one of the plurality of radially extending retaining hooks extends from each of the at least one first axial projection.

3. The bearing device according to claim 2,
wherein the first portion of the electrically insulating insert comprises at least one first radial projection at least partially covering the first axial end of the second ring, the first sealing device directly contacting the at least one first radial projection.

4. The bearing device according to claim 3,
wherein the first ring includes a first axial end and a second axial end axially spaced from the first axial end of the first ring and a first radial side extending from the first axial end of the first ring to the second axial end of the first ring and a second radial side extending from the first axial end of the first ring to the second axial end of the first ring,
wherein an axial width of the second ring is less than an axial width of the first ring, and
wherein the first sealing device is located axially between the first axial end of the first ring and the first axial end of the second ring.

5. The bearing device according to claim 4,
wherein the first radially extending retaining hooks are formed as one piece with the insulating insert.

6. The bearing device according to claim 5,
wherein the first radially extending retaining hooks insert extend radially toward the first ring.

7. The bearing device according to claim 6,
wherein the first sealing device comprises a sealing flange or a sealing gasket.

8. The bearing device according to claim 7,
including a second sealing device mounted on the insulating insert and forming with the first ring a second dynamic annular seal, the insulating insert comprising a plurality of circumferentially spaced second radially extending retaining hooks holding the second sealing device against a second portion of the electrically insulating insert,
wherein the second sealing device is located on an axially opposite side of the second ring from first sealing device.

9. The bearing device according to claim 1,
wherein the electrically insulating insert comprises a central portion overlying the second radial side of the second ring,
wherein the first portion of the electrically insulating insert extends from the central portion and overlies at least a portion of the first radial side of the second ring,
wherein at least one first axial projection extends from the first portion of the electrically insulating insert,
wherein at least one of the plurality of radially extending retaining hooks extends from each of the at least one first axial projection,
wherein the first sealing device comprises a sealing flange or a sealing gasket, and
wherein the first radially extending retaining hooks hold the first sealing device against the first portion of the electrically insulating insert.

10. An electric motor comprising:
a housing,
a shaft, and
a bearing device according to claim 1 mounted radially between the housing and the shaft.
